(19) United States
(12) Patent Application Publication
(10) Pub. No.: US 2014/0063252 A1
(43) Pub. Date: Mar. 6, 2014

(54) METHOD FOR CALIBRATING AN IMAGE CAPTURE DEVICE

(71) Applicant: DELPHI TECHNOLOGIES, INC., TROY, MI (US)

(72) Inventors: KUN ZHAO, DUISBURG (DE); URI IURGEL, WUPPERTAL (DE); MIRKO MEUTER, ERKRATH (DE); DENNIS MUELLER, ERKRATH (DE); CHRISTIAN NUNN, HUCKESWAGEN (DE)

(21) Appl. No.: 14/011,025

(22) Filed: Aug. 27, 2013

(30) Foreign Application Priority Data
Aug. 29, 2012 (EP) 12182248.0

(51) Int. Cl. H04N 17/00

(52) U.S. Cl. CPC H04N 17/002
USPC 348/148

(57) ABSTRACT

In a method for calibrating an image capture device that is mounted on a motor vehicle and able to successively capture images of a road area located in front of the vehicle, at least two image objects which correspond to line segments which are straight and substantially parallel to each other in world coordinates are detected in a captured image. With the aid of the image objects, the position of a vanishing point in the captured image is estimated and tracked by a tracking method. In the process, an error is calculated for the position of the vanishing point. As soon as the calculated error decreases to less than a predetermined threshold value, the image capture device is calibrated with reference to the position of the vanishing point associated with the error.

### CROSS-REFERENCE TO RELATED APPLICATION

This application claims the benefit under 35 U.S.C. §119(a) of European Patent Application EP 12182248.0, filed Aug. 29, 2012, the entire disclosure of which is hereby incorporated herein by reference.

### TECHNICAL FIELD OF INVENTION

This disclosure generally relates to object detection systems for vehicles, and more particularly relates to a method for calibrating an image capture device mounted on a motor vehicle and able to capture successively images of a road area located in front of the vehicle.

### BACKGROUND OF INVENTION

Image capture devices such as cameras are used in many vehicles as input sensors for various kinds of driver assistance systems such as for lane departure warning systems, vehicle and pedestrian detection systems, and systems for automatic road sign detection or for automatic beam height control. In applications of this kind, it is generally preferable to determine the position of the objects of interest in world coordinates with reference to the position of detected image objects in image coordinates. For this conversion between image coordinates and world coordinates, calibration of the camera is necessary. Here, a distinction is made between intrinsic and extrinsic calibration. In so-called intrinsic calibration, the parameters of the image capture device itself are determined, e.g. the focal length of the camera lens or the position of the optical axis. In so-called extrinsic calibration, the position and orientation of the camera relative to the associated vehicle are determined. The extrinsic calibration parameters are in general different for each vehicle. This is firstly due to unavoidable assembly tolerances which arise both during manufacture and in case of maintenance or repair, and secondly due to possible movement of the mounted image capture device as a result of changes in loading status of the vehicle. For example, the angle of inclination of a camera that is mounted in the cab of a truck can vary relatively greatly, depending on the truck's load. To ensure reliable operation of the driver assistance systems concerned, regular and precise calibration of the associated image capture device is therefore highly important. For a user, however, it is tedious always to ensure correct calibration of the image capture device. Also it is difficult to determine the extrinsic calibration parameters, e.g. the angle of inclination of the camera, without expensive additional sensors, but only with the aid of the captured images themselves.

### SUMMARY OF THE INVENTION

Described herein is means to enable reliable calibration of an image capture device mounted on a motor vehicle based on determining a vanishing point in images captured by the image capture device.

In accordance with one embodiment, a method for calibrating an image capture device that is mounted on a motor vehicle and able to capture successively images of a road area located in front of the vehicle is provided. The method includes detecting at least two image objects that correspond to line segments which are straight and substantially parallel to each other in world coordinates in a captured image. The method also includes estimating a position of a vanishing point in the captured image based on the image objects. The method also includes tracking the estimated position of the vanishing point in subsequently captured images. The method also includes calculating an error of the position of the vanishing point. The method also includes calibrating the image capture device with a reference to the position of the vanishing point based on the error if the error is less than a threshold value.

According to one embodiment, at least two image objects that correspond to line segments that are straight and substantially parallel to each other in world coordinates are detected in a captured image. With the aid of the image objects, the position of a vanishing point in the captured image is estimated. By a tracking method the estimated position of the vanishing point is tracked in subsequently captured images and an error is calculated for the position of the vanishing point. As soon as the calculated error decreases to less than a predetermined threshold value, the image capture device is calibrated with reference to the position of the vanishing point associated with the error.

The vanishing point is therefore determined with reference to those image objects which can be assumed to be rectilinear and parallel to each other in world coordinates. It must be considered here that the detection of image objects is always fraught with a certain uncertainty, and these image objects may not be rectilinear and parallel in the strict sense in each individual captured image. It is preferable that those image objects that generally converge on a vanishing point are used.

For instance, these image objects can involve so-called line segments that are extracted from lane markings detected bit by bit. In comparison with determining the vanishing point by texture analysis, which involves intensive computing, and with determining the vanishing point by means of detected whole lane markings that are not straight on bends and require suitable mathematical modelling, determining the vanishing point with the aid of parallel line segments involves less intensive computing and is therefore suitable for real-time applications. Also, when the road bends, it is possible to determine the vanishing point reliably. As a result of tracking, the results from different successively captured images are filtered in time, so that particularly robust and stable results of estimation of the vanishing point are obtained.

Only if the expected error calculated by the tracking method, that is, the covariance of the tracked position of the vanishing point, is small enough, is the position of the vanishing point considered reliable and used for calibrating the image capture device.

With the aid of the position of the vanishing point determined from the image data, the angle of inclination and/or the lateral pivot angle of the image capture device can be calculated in a basically known manner. As a result, the invention therefore enables quick, efficient and robust online calibration of an image capture device, which can be carried out exclusively with the aid of images captured by the image capture device itself. Preferably, calibration is automatic, i.e. without any user intervention.

Preferably, with the aid of respective image-object errors associated with the detected image objects, a single-image error related to the respective captured image is calculated for the position of the vanishing point. This single-image error can be used as covariance for the tracking method, so that it is made possible to track the position of the vanishing point particularly reliably.

According to an embodiment of the invention, the image-object errors are also propagated in the process of estimating the position of the vanishing point, and the single-image error is determined with the aid of the propagated image-object errors. The single-image error can then be used advantageously as input covariance for the tracking method. Unreliable definition of an ad hoc covariance can in this way be avoided.

Preferably, the position of the vanishing point is estimated directly with the aid of the image objects extended as lines, wherein particularly preferably the vanishing point is deemed to be the point on the image sensor which is at a minimum distance from the image objects extended as lines. Elaborately fitting the image objects into a predetermined course, e.g. modelling of lane markings can thus be avoided.

Preferably, the estimated position of the vanishing point is further tracked as long as the calculated error does not decrease to less than the threshold value. In other words, determination of the vanishing point is carried out iteratively with the aid of images captured one after the other. The use of an erroneous value for the vanishing point in a driver assistance system which is relevant to safety is prevented by this procedure.

According to an embodiment of the invention, tracking of the position of the vanishing point is interrupted and an error message is issued if the calculated error after a predetermined length of time or after a predetermined number of update steps of the tracking method has not decreased to less than the threshold value. In this way an erroneous value for the vanishing point is prevented from being used for calibration. Also, the vehicle driver is informed of the existence of an error, so that he can adopt suitable measures if necessary.

To further minimize the risk of incorrect conversion between world coordinates and image coordinates, issue of a calibration parameter determined from the estimated position of the vanishing point, to a control device which uses the calibration parameter, can be prevented as long as the calculated error has not decreased to less than the threshold value. That is to say, a control device such as a lane detection system is specifically prevented from basing conversion between image coordinates and world coordinates on an incorrect camera calibration.

According to a preferred embodiment of the invention, the tracking method is carried out by means of a recursive estimator, in particular a Kalman filter. Using a Kalman filter proved to be particularly advantageous when tracking an estimated position of a vanishing point.

Preferably, the method is repeated or carried out continuously while the vehicle is running. Repeated performance of the calibration method may mean for example that the image capture device is calibrated at regular intervals. Basically, calibration could also be made dependent on a trigger event such as the actuation of a calibration button. Preferably, however, the method is started without user input.

It is also preferred that the method is performed every time the vehicle is started and/or after each reinstallation of the image capture device. This ensures that any changes in the extrinsic parameters which occur e.g. due to loss of adjustment of the camera or a change of load on the vehicle are compensated in time.

According to an embodiment of the invention, several horizontal image areas are fixed in the image, wherein at least two image objects are detected for each image area and, with the aid of these image objects, the position of a vanishing point for the corresponding image area is estimated. By dividing the image into individual areas in this way, when the road bends a curved image object such as a kerb, a lane marking or a crash barrier can be detected bit by bit in such a way that the instances of detection correspond to straight line segments in spite of the curvature. In other words, due to division into (e.g. strip-like) horizontal image areas, the detected line segments are so short that they can be perceived as straight even when the road bends.

The positions of the vanishing points of the individual image areas can be merged by a filtering method into the position of one vanishing point for the whole image. As a result, the stability and robustness of the method for determining the vanishing point can be further increased. Alternatively, the positions of the vanishing points of the individual image areas can also be used singly one after the other as updates in the tracking method.

According to an embodiment of the invention, the image objects to be detected correspond to sections of a lane marking, a kerb or an object extending along a roadway, e.g. a crash barrier. In other words, the image objects in this embodiment correspond to real objects in the road area to be monitored. It is an advantage here that the method is not confined to the detection and mathematical modelling of lane markings. Rather, the invention allows comparatively high flexibility in the choice of suitable image objects for determining the vanishing point.

As an alternative to the embodiment described above, the image objects to be detected can also correspond to trajectories of image characteristics present in several successively captured images, e.g. peaks of brightness. Therefore, irrespective of existing real objects in the road area to be monitored, different types of objects of interest can also be used in the captured images for determining the vanishing point. For example, a line segment can be defined by comparing the positions of an image object of interest in several images captured one after the other. However, this is not absolutely necessary. A line segment can also be fixed on the basis of a single camera image, e.g. by using a previously fixed reference position for the comparison. The vanishing point can be determined favourably by means of image objects of interest even when no lane markings, kerbs or crash barriers can be detected in the road area to be monitored.

The invention also relates to a computer program with program code means for carrying out a method as described above, when the computer program is run on a computer or corresponding computing unit.

Furthermore, the invention relates to a computer program product with program code means which are stored on a computer-readable data carrier, for carrying out a method as described above, when the computer program is run on a computer or corresponding computing unit.

Lastly, the invention also relates to an apparatus for calibrating an image capture device which is mounted on a motor vehicle and connected to a data processing device which is designed to carry out a method as described above.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a schematic view of an image capture device mounted on a motor vehicle that illustrates the relationship between the angle of inclination of the image capture device and the position of a vanishing point in the captured image in accordance with one embodiment;

FIG. 2 is an image of a road area taken by the image capture device as in FIG. 1 in accordance with one embodiment;

FIG. 3 is a flow chart of a method for calibrating the image capture device in FIG. 1, in accordance with one embodiment; and

FIG. 4 is a diagram of the relationship between various system states of an image processing system configured to carry out the method shown in FIG. 3, in accordance with one embodiment.

### DETAILED DESCRIPTION

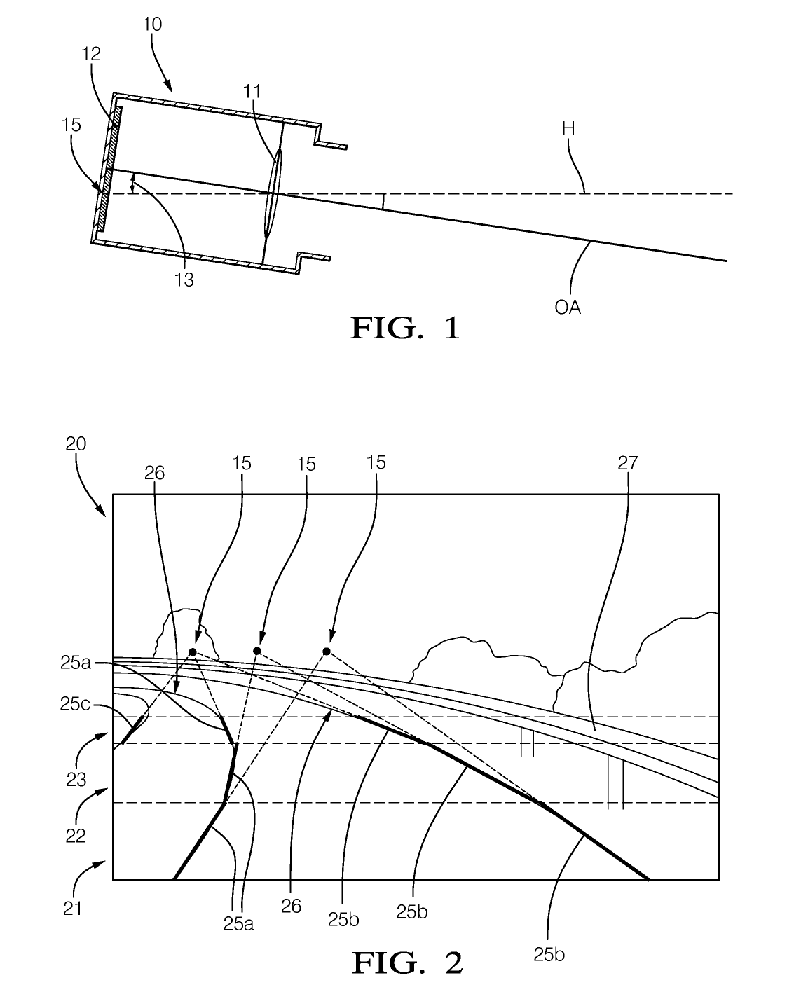

FIG. 1 illustrates a non-limiting example of an image capture device 10 in the form of a digital camera, hereafter often the camera 10. The camera 10 (or image capture device 10) generally has an objective lens 11 and an image sensor 12, for example a CCD chip. The camera 10 is attached to a motor vehicle (not shown) and is designed to successively capture images of a road area located in front of the vehicle. Those in the art will recognize that the camera 10 is typically coupled to a subsequent image processing device (not shown) and together with the latter may form an image processing system.

The camera 10 and the associated image processing device are associated with one or more driver assistance systems, for example a system for preventing lane departure (lane departure warning system). The camera 10 is tilted downwards so that the optical axis OA of the camera 10 forms with the horizon line H an angle of inclination 13. As can be seen in FIG. 1, the position of the vanishing point 15 on the image sensor 12 correlates with the quantity of the angle of inclination 13. Determining the position of the vanishing point 15 therefore allows calibration of the camera 10 in such a way that the current actual angle of inclination 13 is determined and filed in a memory or issued to a control device.

FIG. 1 illustrates a non-limiting example of an image 20 of the road area located in front of the vehicle that was detected by the camera 10. To calibrate the camera 10, a lower portion of the image 20 is first divided into several horizontal image areas 21, 22, 23. Here it must be pointed out that the division into three horizontal image areas 21, 22, 23, as shown by broken lines in FIG. 2, is chosen only for clarification, and can be considerably finer (i.e. closer together) if needed. In each of the horizontal image areas 21, 22, 23, two image objects 25a, 25b, which correspond to line segments that are characterized as straight and parallel to each other in world coordinates (as opposed to camera coordinates), are detected by the image processing device. In the example shown, the image objects 25a, 25b are bits of a detected lane marking 26. When the image objects 25a, 25b are detected, therefore, individual bits of a lane marking 36 to be tracked are detected, i.e. the image objects 25a, 25b are detected in such a way that individual instances of detection are performed bit by bit on a lane marking 26, a curb or a crash barrier 27, and these individual instances of detection bit by bit are perceived as image objects 25a, 25b which are straight and parallel to each other in world coordinates. In particular in each case a position and a pitch for the rectilinear lane marking bits are taken into consideration. As can be seen in FIG. 2, in the upper horizontal image area 23 there are even three parallel lane markings 26, of which the detection bits are all used as image objects 25a, 25b, 25c for determining the vanishing point 15 in the upper horizontal image area 23. Each of the image objects 25a, 25b, 25c is assigned a variance in the form of an image-object error which is taken into consideration when estimating the vanishing point 15 as described below.

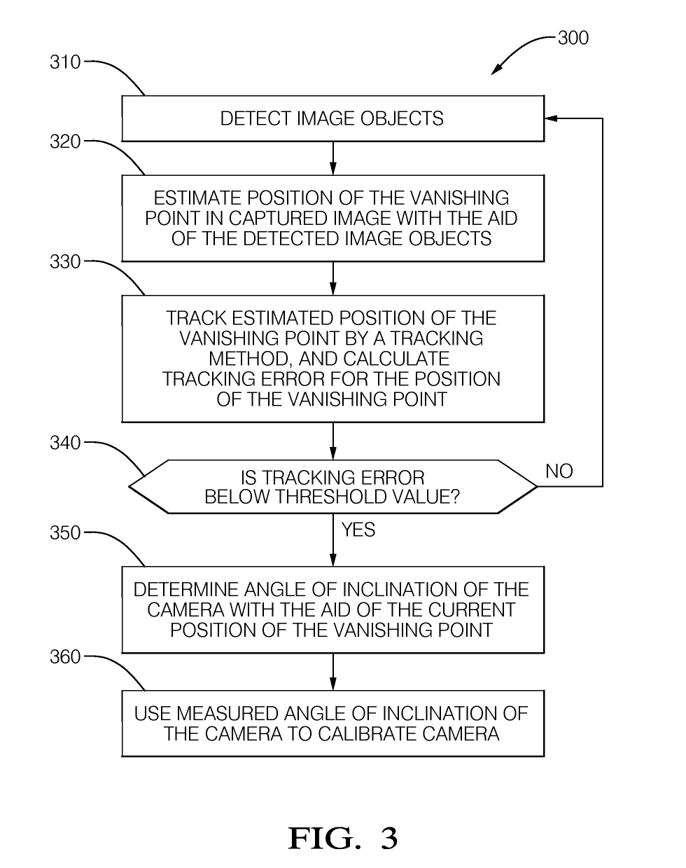

Projection of the road surface onto the image sensor 12 causes paired line segments that are parallel to each other in world coordinates (i.e. not intersecting) to intersect in camera coordinates as shown in captured image 20. This effect is used to determine the position of the vanishing point 15. As shown in FIG. 3, the virtual point of intersection of the respective image objects 25a, b, c is determined separately for each horizontal image area 21, 22, 23. The point on the image sensor 12 that is at a minimum Euclidean distance from all lines of the horizontal image area concerned is determined specifically for this purpose. This point is regarded as the estimated vanishing point 15. Determination of the vanishing point 15 can be formulated as an optimization problem and solved for example by the weighted least-squares method. This method is comparatively robust in relation to outliers, i.e. in relation to erroneously detected image objects 25a, 25b, 25c which do not point in the direction of the vanishing point 15. In the calculations for solving the optimization problem, the above-mentioned image-object errors are propagated as well, in order thus to obtain a covariance in the form of a single-image error for the position of the vanishing point 15 in the image 20 concerned.

As can be seen from FIG. 2, when the road bends the vanishing points 15 for the individual horizontal image areas 21, 22, 23 lie in different positions. However, this deviation concerns only the horizontal position of the vanishing points 15, i.e. the image coordinate X, while the vertical position of the vanishing points 15, i.e. the image coordinate Y, is the same for all horizontal image areas 21, 22, 23. The image coordinate Y of a vanishing point 15 can therefore be used directly to determine the angle of inclination 13 of the camera 10 and to calibrate it on this basis. For each image area 21, 22, 23, by propagating the corresponding image-object errors, a separate single-image error is determined for the position of the vanishing point 15. If the image coordinate X of the vanishing point 15 is needed to calibrate the camera 10 as well, e.g. in order to determine the lateral pivot angle, then the horizontal positions of the vanishing points 15 in the individual horizontal image areas 21, 22, 23 could basically be merged by known filtering methods into a common vanishing point (not shown) for the whole image 20. When the road is straight, separate determination of vanishing points 15 in the individual horizontal image areas 21, 22, 23 does not matter.

It turned out that determining the vanishing point 15 on the basis of a single captured image 20 is in practice too imprecise and too unreliable to guarantee correct calibration. The measured position of the vanishing point 15 is therefore tracked by a tracking method using a Kalman filter in successively captured images 20. Here, in a manner which is basically known, an expected error for the position of the vanishing point 15 is calculated. Only when this error is small enough to be able to assume a reliable estimate, is the actual calibration carried out. That is to say, as soon as the calculated error decreases to less than a predetermined threshold value, the camera 10 is calibrated with the aid of the position of the vanishing point 15 associated with the error. Specifically, the estimated status variance in the Kalman filter can be used as a criterion for ending the tracking process.

On the basis of the simplified pinhole camera model as in FIG. 1, and assuming a roll angle of zero, the angle of inclination 13 and the lateral pivot angle of the camera 10, which is not visible in FIG. 1, are calculated additionally using the known intrinsic calibration parameters and stored and/or outputted. The calibration process is then over.

FIG. 3 illustrates a non-limiting example of a method 300 for calibrating the camera 10. Step 310, DETECT IMAGE OBJECTS, may include steps where for each horizontal image area 21, 22, 23 the corresponding lane marking bits are detected as image objects 25a, 25b, 25c. Step 320, ESTIMATE POSITION OF THE VANISHING POINT IN CAPTURED IMAGE WITH THE AID OF THE DETECTED IMAGE OBJECTS, may include steps where, as described above, the position of the vanishing point 15 in the captured image 20 is estimated with the aid of the detected image objects 25a, 25b, 25c. Step 330, TRACK ESTIMATED POSITION OF THE VANISHING POINT BY A TRACKING METHOD, AND CALCULATE TRACKING ERROR FOR THE POSITION OF THE VANISHING POINT, may include steps where the estimated position of the vanishing point 25 is tracked by a tracking method, calculating a tracking error for the position of the vanishing point 15 using a predetermined single-image error. Step 340, IS TRACKING ERROR BELOW (i.e. less than) THRESHOLD VALUE?, may include steps where it is checked whether the tracking error decreases to less than a predetermined threshold value. In the event that the tracking error decreases to less than the threshold value, Step 350, DETERMINE ANGLE OF INCLINATION OF THE CAMERA WITH THE AID OF THE CURRENT POSITION OF THE VANISHING POINT, may include steps where the angle of inclination 13 of the camera 10 is determined with the aid of the current position of the vanishing point 15. Step 360, USE MEASURED ANGLE OF INCLINATION OF THE CAMERA TO CALIBRATE CAMERA, may include steps where the measured angle of inclination 13 of the camera 10 is used to calibrate the camera 10. In the event that in step 340 the tracking error does not decrease to less than the threshold value, there is a return to step 310, and detection of the image objects 25a, 25b, 25c, estimation of the position of the vanishing point 15 and tracking of the estimated position of the vanishing point 15 are repeated with the aid of the next captured image 20. If the tracking error after a predetermined length of time or after a predetermined number of update steps of the tracking method has not decreased to less than the threshold value, tracking of the position of the vanishing point 15 is interrupted and an error message is issued. Furthermore, output of an angle of inclination 13 determined from the estimated position of the vanishing point 15, to a control device which uses the angle of inclination 13, is prevented as long as the tracking error has not decreased to less than the threshold value.

The method is performed continuously while the vehicle is running and started without user input. Instead of the detection of lane marking bits as shown in FIG. 2, curbs, crash barriers 27 or trajectories of image objects of interest (not shown) can be used as the image objects to be detected.

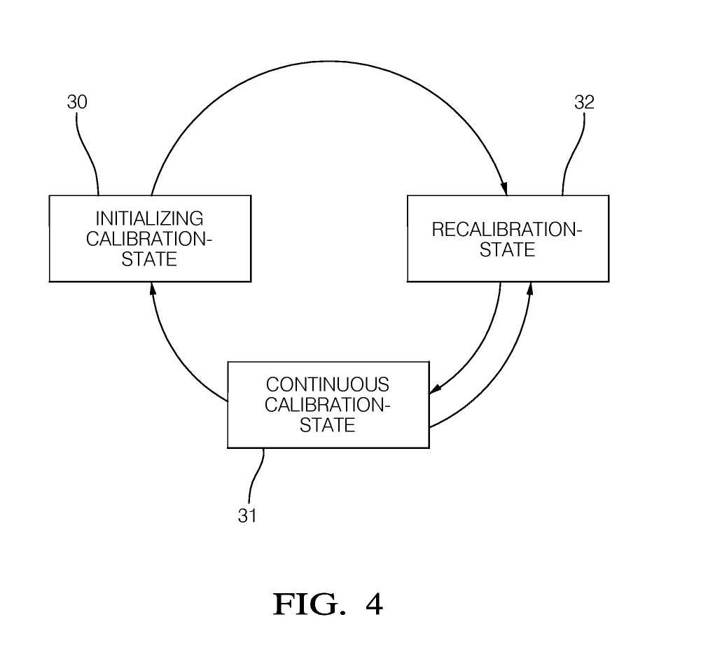

The image capture system which carries out the method described above can adopt three different calibration states 30, 31, 32, as shown in FIG. 4. Depending on whether certain conditions are fulfilled, the image capture system can start from each of the three calibration states 30, 31, 32 and change between the individual calibration states 30, 31, 32 while the calibration method is being carried out. Usually the method starts with the initializing calibration state 30 if there is no a priori information on the extrinsic parameters of the camera 10. For instance, the system starts in the initializing calibration state 30 when the camera 10 has been newly installed or the assembly position as well as the angle of orientation have been altered within the scope of maintenance or repair. The main aim of the initializing calibration state 30 is to calibrate the camera 10 as quickly as possible, taking precision standards into consideration. Since there is no a priori information on the extrinsic parameters of the camera 10 in the initializing calibration state 30, no conversion between world coordinates and image coordinates can be carried out by a subsequent system such as a driver assistance system. Applications which depend on this conversion therefore cannot be run if the calibration is not successful. Therefore tracking of the position of the vanishing point 15 is interrupted and an error message is given out when the calculated error after a predetermined length of time or after a predetermined number of update steps of the tracking method has not decreased to less than the threshold value.

In the event that the target of the initializing calibration state 30 is reached, however, the system changes automatically to the continuous calibration state 31. In the event that a priori information on the extrinsic parameters of the camera 10 is available, the system can also start in the continuous calibration state 31. The a priori information can come from stored results of a calibration process carried out previously or be based on an estimate. In the continuous calibration state 31, the system checks the accuracy of the calibration result online by comparing it with the current estimate. In the event that a deviation is found here, the system can output the current estimate as a calibration result as a function of the degree of deviation and retain the continuous calibration state 31 or change to the initializing calibration state 30. In the event that the system delivers the result as an output to other applications, it changes to the recalibration state 32. If needed, the system can stay in this state. Some applications which depend on conversion between world coordinates and image coordinates need a certain amount of time to react to a new calibration of the camera 10. After the calibration results have been processed by the applications concerned, the system preferably changes back to the continuous calibration state 31.

As described, a calibration method according to the invention uses e.g. lane markings 26 detected bit by bit, directly in a robust estimation process in order to determine the vanishing point 15 of the camera 10 even when the road bends. An advantage here lies in that detection of lane markings bit by bit in this way is frequently carried out anyway, for example within the framework of lane departure warning, and therefore can be used for calibration as well in an efficient manner. Furthermore it is an advantage that a calibration method according to the invention does not depend on mathematical modeling or regression. Nor is it important for the method whether there are exactly two lane markings or more, whether the width of the lane markings corresponds to a given standard, or whether they are continuous or broken lane markings. The invention therefore allows particularly efficient and reliable calibration of a camera 10 in continuous, automatic operation under various conditions.

While this invention has been described in terms of the preferred embodiments thereof, it is not intended to be so limited, but rather only to the extent set forth in the claims that follow.

We claim:

1. A method for calibrating an image capture device mounted on a vehicle and able to capture successively images of a road area located in front of the vehicle, said method comprising:
detecting in a captured image at least two image objects that correspond to line segments characterized as straight and substantially parallel to each other in world coordinates;
estimating a position of a vanishing point in the captured image based on the image objects;
tracking the position of the vanishing point in subsequently captured images, and calculating an error for the position of the vanishing point; and
calibrating the image capture device with the position and the error if the error is less than a threshold value.

2. The method according to claim 1, wherein the method includes
calculating a single-image error for the position of the vanishing point that is related to the respective captured image and based on respective image-object errors associated with the detected image objects.

3. The method according to claim 2, wherein the image-object errors are also produced in the process of estimating the position of the vanishing point, and the single-image error is determined based on the propagated image-object errors.

4. The method according to claim 1, wherein the position of the vanishing point is estimated directly based on the image objects extended as lines, wherein the vanishing point is deemed to be the point on the image sensor that is at a minimum distance from the image objects extended as lines.

5. The method according to claim 1, wherein the estimated position of the vanishing point is further tracked as long as the calculated error is not less than the threshold value, and tracking of the position of the vanishing point is interrupted and an error message is issued if the calculated error after a predetermined length of time or after a predetermined number of update steps of the tracking method has not decreased to less than the threshold value.

6. The method according to claim 1, wherein the method further comprises
preventing the issuing of a calibration parameter determined from the estimated position of the vanishing point to a control device that uses the calibration parameter if the calculated error has not decreased to less than the threshold value.

7. The method according to claim 1, wherein the step of tracking is carried out by a recursive estimator.

8. The method according to claim 1, wherein the method is repeated continuously while the vehicle is running, and the method is performed every time the vehicle is started and after each reinstallation of the image capture device.

9. The method according to claim 1, wherein a plurality of horizontal image areas are fixed in the image, wherein at least two image objects are detected for each image area and, based on these image objects, the position of a vanishing point for the corresponding image area is estimated.

10. The method according to claim 9, wherein the positions of the vanishing points of the individual image areas are merged by a filtering method into the position of a vanishing point for the whole image.

11. The method according to claim 1, wherein the image objects to be detected correspond to one of sections of a lane marking, a kerb extending along a roadway, and an object extending along the roadway.

12. The method according to claim 1, wherein the image objects to be detected correspond to trajectories of image characteristics present in several successively captured images.

13. An apparatus for calibrating an image capture device that is mounted on a motor vehicle and connected to a data processing device configured to carry out a method according to claim 1.

14. A method for calibrating an image capture device (10) which is mounted on a motor vehicle and able to successively capture images (20) of a road area located in front of the vehicle, wherein
at least two image objects (25a, 25b) which correspond to line segments which are straight and substantially parallel to each other in world coordinates are detected in a captured image (20),
based on the image objects (25a, 25b), the position of a vanishing point (15) in the captured image (20) is estimated,
by a tracking method the estimated position of the vanishing point (15) is tracked in subsequently captured images (20) and, by said same tracking method, an error is calculated for the position of the vanishing point (15), and
as soon as the calculated error falls below a predetermined threshold value, the image capture device (10) is calibrated with reference to the position of the vanishing point (15) associated with the error.

15. The method according to claim 14, characterized in that
based on respective image-object errors associated with the detected image objects (25a, 25b), a single-image error related to the respective captured image (20) is calculated for the position of the vanishing point (15).

16. Method according to claim 15, characterized in that
the image-object errors are also produced in the process of estimating the position of the vanishing point (15), and the single-image error is determined based on the propagated image-object errors.

17. The method according to claim 14, characterized in that
the position of the vanishing point (15) is estimated directly based on the image objects (25a, 25b) extended as lines, wherein preferably the vanishing point (15) is deemed to be the point on the image sensor (12) which is at a minimum distance from the image objects (25a, 25b) extended as lines.
